(19) United States
(12) Patent Application Publication
(10) Pub. No.: US 2014/0354542 A1
(43) Pub. Date: Dec. 4, 2014

(54) INTERACTIVE DISPLAY SYSTEM

(71) Applicant: National Taiwan Normal University, Taipei (TW)

(72) Inventors: Chun-Yen CHANG, Taipei City (TW); Wei-Kai LIOU, New Taipei City (TW)

(73) Assignee: National Taiwan Normal University, Taipei (TW)

(21) Appl. No.: 14/073,599

(22) Filed: Nov. 6, 2013

(30) Foreign Application Priority Data
May 30, 2013 (TW) 102119029

(51) Int. Cl. G06F 3/0346

(52) U.S. Cl. CPC G06F 3/0346
USPC 345/157

(57) ABSTRACT

An interactive display system including a data processing unit, a display, a laser pointer, a translucent optical device, an image capture device, and an optical filter is disclosed. The laser pointer projects a laser beam on the translucent optical device attached to or built in a screen of the display. The laser beam has a specified wavelength within a visible light spectrum. The translucent optical device reflects most of the laser beam. The image capture device acquires under the data processing unit a sensed image including a part of a displayed object image within the specified wavelength and the reflected laser beam. The data processing unit determines a position of the laser beam relative to the displayed object image in accordance with light intensity distribution of the sensed image, calculates a distance vector between the determined position and a cursor, and moves the cursor according to the distance vector.

### CROSS-REFERENCE TO RELATED APPLICATION

This application claims the benefit of the filing date of Taiwan Patent Application No. 102119029, filed on May 5, 2013, the disclosure of which is incorporated herein in its entirety by reference.

### BACKGROUND OF THE DISCLOSURE

1. Field of the Disclosure

The invention relates to an interactive display system; and, more particularly, it pertains to an interactive display system in which a laser pointing device is used to control motion of mouse cursor on the screen of a monitor.

2. Brief Description of the Related Art

As to interactive display system, one prior art utilizes the external coordinates of the image of the laser beam (pointer) on projector's screen to transform into the internal coordinates to the computer controlling the cursor's action. The external coordinates of the image of the laser beam are detected by the optical device (lens). This approach allows for the laser light on a projector screen to be utilized in a manner similar to that of a cursor being controlled by a mouse conventionally.

The displayed information on the screen is projected by a typical projector using high intensity visible light. The power of the laser light source must be intentionally enhanced to ensure the laser beam on the screen, which has the displayed information thereon as well, can be effectively sensed by the optical lens. Under this condition, the user's eyes are easily exposed to and possibly damaged by high-power laser light. Therefore, unlike the system of interactive electronic whiteboards, the technique of the laser-guided cursor is generally not applicable for interactive teaching and presentation systems for safety reasons.

The above mentioned conventional approaches only apply to system utilizing the projector screen. Furthermore, various state-of-art display devices such as liquid-crystal displays and organic-light-emitting diode displays can not be used in the above conventional interactive display systems since they could not reflect laser light. In other words, the optical device can not detect reflected signal from the screen of liquid-crystal displays or organic light-emitting diode displays. Therefore, the laser-guided-cursor based techniques can not be realized in systems having liquid-crystal display devices or organic light-emitting diode display devices.

### SUMMARY OF THE DISCLOSURE

The instant invention discloses an interactive display system that uses laser light as the pointer to control the cursor's action on displays not having reflection capability.

In one embodiment of the instant invention, an interactive display system includes a data processing unit, a display having a screen, a laser pointer, a translucent optical unit, an image capturing device, and an optical filter. The display has a screen configured to communicate with the data processing unit and to display an object image output from the data processing unit on the screen, the object image including a cursor generated by the data processing unit. The translucent optical unit is either externally attached to the screen or built in the screen, the translucent optical unit being disposed in front of the screen. The laser pointer is configured to emit a laser beam onto the translucent optical unit, the laser beam having a specified wavelength in visible-light range, wherein the translucent optical unit is capable of reflecting a larger portion of the laser beam. The image capture device has a lens and configured to communicate with the data processing unit. The optical filter is either attached to the lens externally or built in the lens for allowing passage of light beam reflected from the translucent optical unit. The image capture device acquires a sensed image retrieved from the image capture device and the data processing unit determines a position of the reflected laser beam with respect to the object image according to light intensity distribution of the sensed image, calculates a distance vector between the position of the reflected laser beam and the cursor, and moves the cursor according to the distance vector, wherein the sensed image including a part of the displayed object image of the specified wavelength and the reflected laser beam.

Further, the interactive display system of the instant invention includes a remote command transmitter for transmitting the command in a wireless way to the data processing unit.

Compared with prior art, the interactive display system of the instant invention is operable in combination with state-of-art display devices and render a lowest damage to users eyes.

The characteristics, realization and functions of the invention are disclosed in the following description with reference to the preferred exemplified embodiments and the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of an arrangement of an interactive display system according to a preferred embodiment of the instant invention;

FIG. 2 is a schematic diagram of a distance vector between a cursor and a laser beam on the screen.

### DETAILED DESCRIPTION OF THE INVENTION

The instant invention now will be described more fully herein with reference to the accompanied figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” used in this specification do not preclude the presence or addition of one or more other selectivity features, steps, operations, elements, components, and/or groups thereof. And the term “and/or” includes any and all combinations of one or more of the associated listed items.

Unless otherwise defined, all terms used herein have the same meaning as commonly understood by one of ordinary skill in the art to which this invention belongs. It will be further understood that terms defined in commonly used dictionaries will not be interpreted in an idealized or overly formal sense unless expressly so defined herein.

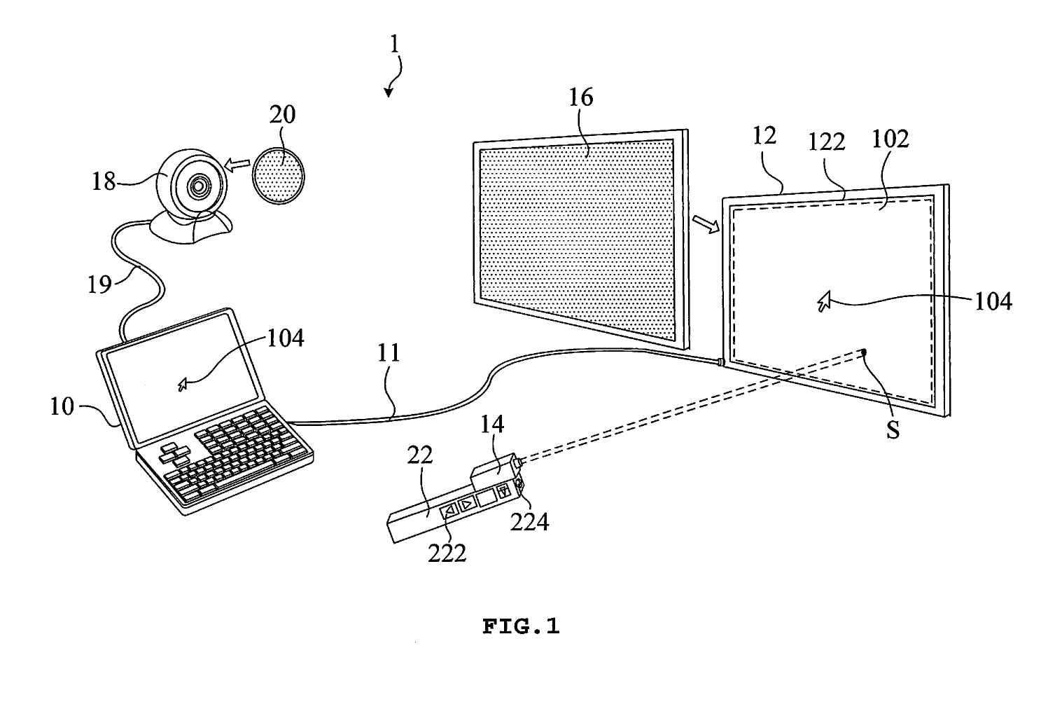

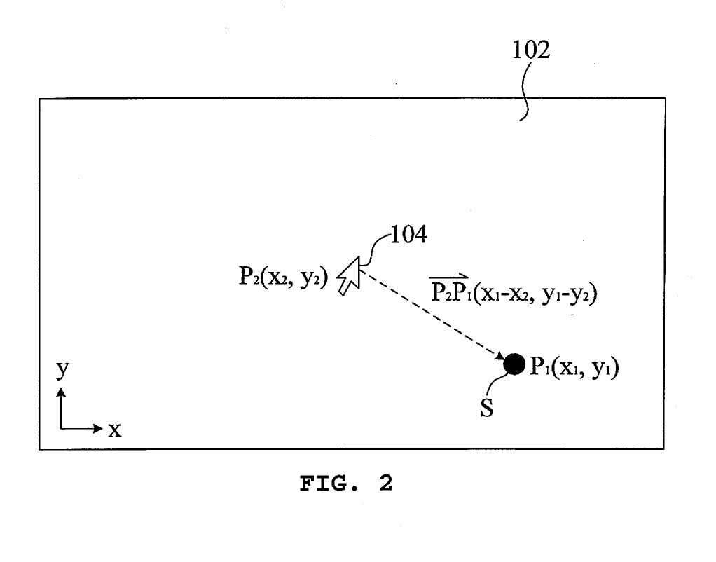

FIG. 1 is a schematic view of the structure of an interactive display system 1 according to a preferred embodiment of the instant invention, and FIG. 2 is a schematic view illustrating a displacement vector \vec{P₂P₁} between a cursor 104 and spot of a laser beam S.

As shown in FIG. 1, the interactive display system 1 of the instant invention includes a data processing unit 10, a display 12 with a screen 122, a laser pointer 14, a translucent optical unit 16, an image capture device 18, and an optical filter 20. The display 12 may be, for example, a liquid crystal display (LCD) or a light emitting diode (LED) display, and it is noted that the screen 122 of the display 12 can not reflect the laser light and is used to display the object image 102.

The display 12 is electrically connected to and, therefore, can communicate with the data processing unit 10 through a cable 11, for example, as illustrated in FIG. 1. As known in the arts, data may be transmitted wirelessly between the display 12 and the data processing unit 10 also. Besides, the display 12 displays an object image 102 that is output from the data processing unit 10 on the screen 122. The object image 102 contains a cursor 104 which is generated by the data processing unit 10 to that a mouse is attached.

The translucent optical unit 16 may be attached to or built in the screen 122 in this instant invention. In the embodiment of FIG. 1, the translucent optical unit 16 is attached to the screen 122 externally for illustration purpose. The translucent optical unit 16 is disposed in front of the screen 122 while in actual use of system. The laser pointer 14 serves to emit a laser beam S on the translucent optical unit 16 first and then on the screen 122. For the purpose of clear depiction, the translucent optical unit 16 and the screen 122 are shown separately and the laser beam S is projected on the screen 122 in FIG. 1. It is appreciated that, in reality, the laser beam S is projected on the translucent optical unit 16 and the screen 122 as well.

The laser beam S has a specified wavelength of the visible spectrum. For example, the laser beam S could be the red light in a wavelength range of 650-660 nm, the green light of 532 nm, the orange light of 593.5 nm, the blue light of 445-450 nm or the violet light of 405 nm.

The translucent optical unit 16 is so selected that it is able to reflect a larger portion of the laser beam S, i.e., to reflect most amount of the laser beam S. The translucent optical unit 16 is typically made of plastic film, acrylics, or glass that reflects the laser beam S effectively while without affecting the presentation of the object image 102 to the viewers of the object image 102. Alternatively in a not shown embodiment, the translucent optical unit 16 is configured as an internal part of the display 12 to lay over the screen 122.

The image capture device 18 includes a lens (e.g., at center of device 18) and can communicate with the data processing unit 10. In FIG. 1, the image capture device 18 is electrically connected to the data processing unit 10 by a cable 19. In another not shown embodiment, the image capture device 18 is formed integrally with the data processing unit 10, such as a notebook computer, tablet PC or Smartphone having a built-in camera.

An optical filter 20 may be attached to or built within the lens of the image capture device 18. In the shown embodiment of FIG. 1, the optical filter 20 is attached to the lens 182. Particularly, the optical filter 20 is configured to allow the light of the specified wavelength mentioned in paragraph of [0022] to pass.

The image capture device 18, under the control of the data processing unit 10, acquires a sensed image that contains a part of the object image 102 of the specified wavelength and the reflected laser beam from the translucent optical unit 16. The laser beam S is generated by the laser pointer 14 of low power and it is still brightest among the sensed image processed by the data processing unit 10. As shown in FIG. 2, the data processing unit 10 determines the position P1(x₁, y₁) of the laser beam S with respect to the object image 102, according to light intensity distribution of the sensed image received by the image capture device 18.

As shown in FIG. 2, the data processing unit 10 calculates a distance vector \vec{P₂P₁} (x₁-x₂, y₁-y₂), between the determined position P1(x₁, y₁) of the laser beam S, and the position P2(x₂, y₂) of the cursor 104 on the object image 102, and moves the cursor 104 to follow the position of the laser beam S according to the distance vector \vec{P₂P₁} (x₁-x₂, y₁-y₂). While the data processing unit 10 is so programmed, the position of cursor 104 can then be controlled by the laser pointer 14.

Further, as shown in FIG. 1, the interactive display system 1 includes a wireless command transmitter 22 integrated with the laser pointer 14 for transmitting the command wirelessly to the data processing unit 10. The data processing unit 10 then executes the command sent from the wireless command transmitter 22 based on the current position of the cursor 104 to achieve the desired function intended by the user. The wireless command transmitter 22 may include a plurality of function keys 222, each of which corresponds to a specific command. Alternatively, the wireless command transmitter 22 may include a switch configured to switch on the laser pointer 14, or a wireless signal transmitting module 224. When one of the function keys 222 of the wireless command transmitter 22 is activated, a corresponding command is transmitted from the wireless command transmitter 22 through the wireless signal transmitting module 224 to the data processing unit 10. In this way, it is feasible for the user to interact in various ways with the object image 102 output from the data processing unit 10 by using the interactive display system 1 of the instant invention. For example, an object (or function) in the object image 102 may be selected, dragged, amplified, contracted, or rotated, and left-button or right-button of mouse may be pressed. Therefore, the interactive display system 1 of the instant invention is applicable for environments of interactive teaching and presentation systems.

In one embodiment, wireless signal transmission is realized by 2.4 GHz, Bluetooth, Wi-Fi technology, audio, infrared or the like. In one embodiment, the laser pointer 14 of low power includes green visible laser light source of 30 mW power or less for generating the laser beam S. In another embodiment, the laser pointer 14 of low power includes red visible laser light source of 3 mW power or less for generating the laser beam S. Due to the low power selection for the laser pointer 14, the interactive display system 1 will lower the possible damage to the user's eyes.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. An interactive display system, comprising:
a data processing unit;
a display having a screen configured to communicate with the data processing unit and to display an object image output from the data processing unit on the screen, the object image including a cursor generated by the data processing unit;
a translucent optical unit externally attached to the screen or built in the screen, the translucent optical unit being disposed in front of the screen;
a laser pointer configured to emit a laser beam onto the translucent optical unit, the laser beam having a specified wavelength in visible-light range, wherein the translucent optical unit is capable of reflecting a larger portion of the laser beam;
an image capture device having a lens and configured to communicate with the data processing unit;
an optical filter attached to the lens externally or built in the lens for allowing passage of light beam reflected from the translucent optical unit; and
wherein the image capture device acquires a sensed image retrieved from the image capture device and the data processing unit determines a position of the reflected laser beam with respect to the object image according to light intensity distribution of the sensed image, calculates a distance vector between the position of the reflected laser beam and the cursor, and moves the cursor according to the distance vector, wherein the sensed image including a part of the displayed object image of the specified wavelength and the reflected laser beam.

2. The interactive display system of claim 1, further comprising a wireless command transmitter for transmitting a command in a wireless way to the data processing unit.

3. The interactive display system of claim 2, wherein the wireless command transmitter is integrally formed with the laser pointer.

4. The interactive display system of claim 2, wherein the wireless way is selected from one of the group consisting of 2.4 GHz, Bluetooth, Wi-Fi, audio and infrared.

5. The interactive display system of claim 1, wherein the laser beam is selected from one of the group consisting of red light, green light, orange light, blue light and violet light.

6. The interactive display system of claim 1, wherein the laser pointer includes a light source generating red visible laser light of 3 mW power or less.

7. The interactive display system of claim 1, wherein the laser pointer includes a light source generating green visible laser light of 30 mW power or less.
